(19) United States
(12) Patent Application Publication
(10) Pub. No.: US 2013/0089482 A1
(43) Pub. Date: Apr. 11, 2013

(54) WATER RECOVERY AND ACID GAS CAPTURE FROM FLUE GAS

(71) Applicants: Edward G. LATIMER, Ponca City, OK (US); George F. SCHUETTE, Ramona, OK (US); Clint P. AICHELE, Bartlesville, OK (US); Mitchell E. LOESCHER, Tulsa, OK (US); Randall L. HEALD, Bartlesville, OK (US)

(72) Inventors: Edward G. LATIMER, Ponca City, OK (US); George F. SCHUETTE, Ramona, OK (US); Clint P. AICHELE, Bartlesville, OK (US); Mitchell E. LOESCHER, Tulsa, OK (US); Randall L. HEALD, Bartlesville, OK (US)

(73) Assignee: PHILLIPS 66 COMPANY, Houston, TX (US)

(21) Appl. No.: 13/632,181

(22) Filed: Oct. 1, 2012

Related U.S. Application Data
(60) Provisional application No. 61/545,837, filed on Oct. 11, 2011.

(51) Int. Cl. B01D 53/40; B01D 53/48; B01D 53/56

(52) U.S. Cl. CPC B01D 53/40; B01D 53/56; B01D 53/485
USPC 423/235; 423/210; 423/243.01; 423/243.06; 423/243.08

(57) ABSTRACT

Methods for removing acid gases and recovering water from flue gas. A flue gas is introduced into a water spray tower and is cooled by direct contact with a sprayed aqueous stream to condense a portion of the water vapor in the flue gas. Acid gases present in the flue gas are absorbed into the aqueous mixture, and a chemical added to the stream facilitates conversion of absorbed acid gases. The aqueous stream leaving the spray tower is next treated to remove contaminants, such as carbonates and bicarbonates, thereby producing a cleaned aqueous stream that may be split into a stream that is cooled prior to reuse in the spray tower, as well as a stream that is fed back to the boiler.

### CROSS-REFERENCE TO RELATED APPLICATIONS

This application is a non-provisional application which claims benefit under 35 USC §119(e) to U.S. Provisional Application Ser. No. 61/545,837 filed Oct. 11, 2011, entitled “WATER RECOVERY AND ACID GAS CAPTURE FROM FLUE GAS,” which is incorporated herein in its entirety.

### STATEMENT REGARDING FEDERALLY-SPONSORED RESEARCH OR DEVELOPMENT

None

### FIELD OF THE INVENTION

Methods and systems for removing acid gases from a flue gas while simultaneously generating make-up water by recovering water from steam-assisted production boiler flue gas.

### BACKGROUND

Obtaining adequate water for future steam-assisted hydrocarbon production is an area of critical concern. There is a strong possibility that government regulations on water use may eventually require that saline water be utilized for such operations, rather than fresh or “non-saline” water. However, saline water typically contains a high amount of total dissolved solids, and it is expensive to treat such water streams to obtain water suitable for use in steam-assisted hydrocarbon production. Thus, for both environmental and economic reasons, it is important to conserve the water used for these operations.

Many industrial processes produce process streams containing condensable components such as water vapor, and water recovery by condensation from commercial-size boiler flue gas streams has been previously proposed. Discarding these condensable components can constitute a substantial loss in available heat energy. Thus, it is makes economic sense to recover the heat from these condensable components from the process streams. It is also desirable to recover some of the condensable components from the flue gas, particularly the water for those operations where make-up water is needed, as recovering the water can lessen the amount of make-up water required from outside sources. The use of heat exchanger-based condensers for the recovery of condensable components of process streams and the latent heat of vaporization associated therewith is well-established.

U.S. Pat. No. 7,066,396 teaches a heating system having a steam generator or water heater, at least one economizer, at least one condenser and at least one oxidant heater arranged in a manner so as to reduce the temperature and humidity of the exhaust gas stream and recover a major portion of the associated sensible and latent heat. The recovered heat is returned to the steam generator or water heater so as to increase the quantity of steam generated or water heated per quantity of fuel consumed. In addition, a portion of the water vapor produced by combustion of fuel is reclaimed for use as feed water, thereby reducing the make up water requirement for the system. However, U.S. Pat. No. 7,066,396 provides no teaching or suggestion for producing make-up water for a steam-assisted gravity drainage system while simultaneously removing at least one acid gas from the flue gas.

U.S. Pat. No. 4,799,941 pertains to a methods and apparatus for condensing flue gas in combustion plants. U.S. Pat. No. 4,799,941 attempts to condense flue gas in combustion plants by: (a) cooling and humidifying the flue gas by spraying water thereinto; (b) cooling and condensing water vapor from the flue gases in a first condensing stage, by indirect heat exchange with recirculated water, or return water, from a hot water circuit; (c) further cooling and condensing water vapour from the flue gases in a second condensing stage, by indirect heat exchange with water from a combustion air humidifier; and (d) heating and humidifying combustion air in the humidifier by direct contact with heated recirculated water from the second condensing stage. However, U.S. Pat. No. 4,799,941 provides no teaching or suggestion regarding the production of make-up water for a steam-assisted gravity drainage system while simultaneously recovering at least one acid gas present in the flue gas.

### BRIEF SUMMARY

The present disclosure pertains to recovering both water and acid gases from a flue gas. In certain embodiments, the flue gas is produced by combustion within a boiler that makes steam for use in steam-assisted hydrocarbon production. The flue gas is passed into a water spray tower, wherein the flue gas comprises commercial pipeline natural gas and produced gas, or combustion products of these gases. The method cools the flue gas within the water spray tower in order to condense a portion of the water vapor present in the flue gas and produce a water stream. The method then recirculates and cools the water stream exiting the bottom of the spray tower in an air cooler to produce recirculating water. The recirculating water sprayed by the water spray tower may contain a chemical. The method also comprises taking a slipstream off of the recirculating water as make-up water.

The present disclosure also pertains to a steam-assisted gravity drainage facility wherein a portion of the make-up water is recovered from a flue stack. In this steam-assisted gravity drainage facility the make-up water is produced by first reducing the sulfur content, if necessary, of the fuel gas chemically prior to combustion, wherein the fuel gas comprises commercial pipeline natural gas and produced gas. Next the flue gas is introduced into a water spray tower and cooled by direct contact with the water to a temperature that allows the condensation of at least a portion of the water vapor present in the flue gas. A chemical is added to the water used in the water spray tower. Then the water stream exiting the bottom of the spray tower is recirculated and cooled in an air cooler to produce recirculating water. A slipstream is then taken off of the recirculating water as make-up water, wherein the make up water produced has a pH higher than 3.0.

The present disclosure also includes a method of collecting production fluids from a steam-assisted gravity drainage (SAGD) operation. The production fluids are separated into a produced gas stream, a produced oil stream and a produced water stream. The produced water stream is then transported to a boiler wherein the produced water stream is converted for use in the stream assisted gravity drainage operation. The produced gas stream is used as a fuel source for the steam boiler. The flue gas from the boiler is cooled in a water spray tower to condense at least a portion of the water vapor in the flue gas. The condensed water vapor is then collected and transported to a boiler wherein the condensed water vapor is converted to use in the steam-assisted gravity drainage operation.

### BRIEF DESCRIPTION OF THE DRAWINGS

The invention, together with further advantages thereof, may best be understood by reference to the following description taken in conjunction with the accompanying drawings.

FIG. 1 depicts a steam-assisted production facility capable of recovering both water and acid gases from a boiler flue gas.

FIG. 2 is a graphical depiction of the relationship between flue gas temperature and net water recovery.

FIG. 3 is a graphical depiction of the relationship between flue gas temperature, water circulation rate, and recirculating water temperature.

### DETAILED DESCRIPTION

Prior work by ConocoPhillips inventors has described various methods for recovery of water from the flue gas of boilers in association with steam-assisted hydrocarbon recovery. These methods have been documented in the following patent applications, all of which are hereby incorporated herein in their entirety. U.S. Provisional Patent Application 61/226,523 (filed Jul. 17, 2009) and U.S. patent application Ser. No. 12/837,001 (filed Jul. 15, 2010), both entitled “Water Recovery from Flue Gas in Steam Assisted Production”. U.S. Provisional Patent Application 61/226,523 (filed Jul. 17, 2009) entitled “Water Recovery From Steam-Assisted Heavy Oil Production Boiler Flue Gas” and U.S. patent application Ser. No. 12/837,001 (filed Jul. 15, 2010), entitled Water Recovery from Flue Gas in Steam-Assisted Production”.

The present method provides a method of contacting a flue gas with sprayed water in a water spray tower, wherein the flue gas comprises combustion products of commercial pipeline gas and produced gas, preferably produced in a boiler. The flue gas is cooled by the sprayed water within the water spray tower to condense at least a portion of the water vapor in the flue gas, thereby producing a reclaimed water stream. The sprayed water used to cool the flue gas in the spray tower also absorbs at least a portion of the acid gases contained within the flue gas. At least one chemical is added to the sprayed water that reacts with absorbed acid gases to produce carbonates and bicarbonates. The reclaimed water stream combines with the sprayed water and is transported to a reactor where the carbonates and bicarbonate are removed from the water stream, thereby producing a recirculating water stream. A portion of this recirculating water may be cooled in a heat-exchanger and used again as sprayed water in the water spray tower. Another portion of the recirculating water, approximately equivalent to the amount of water reclaimed from the flue gas, may be removed as a slipstream and used as boiler feed water for a steam-assisted hydrocarbon production process. Examples of steam-assisted hydrocarbon production methods applicable to this method include steam assisted gravity drainage and cyclical steam stimulation.

The present method has the ability to reclaim enough water from the flue gas to produce more than 50% of the boiler feed make-up water for the steam-assisted hydrocarbon production process. Both environmental and economic benefits are achieved by recycling the water used in a steam-assisted hydrocarbon production process. The present method has the additional benefit of removing a significant portion of the acid gases present in the flue gas and converting the acid gases to carbonates and bicarbonates, which have a negligible impact on the environment.

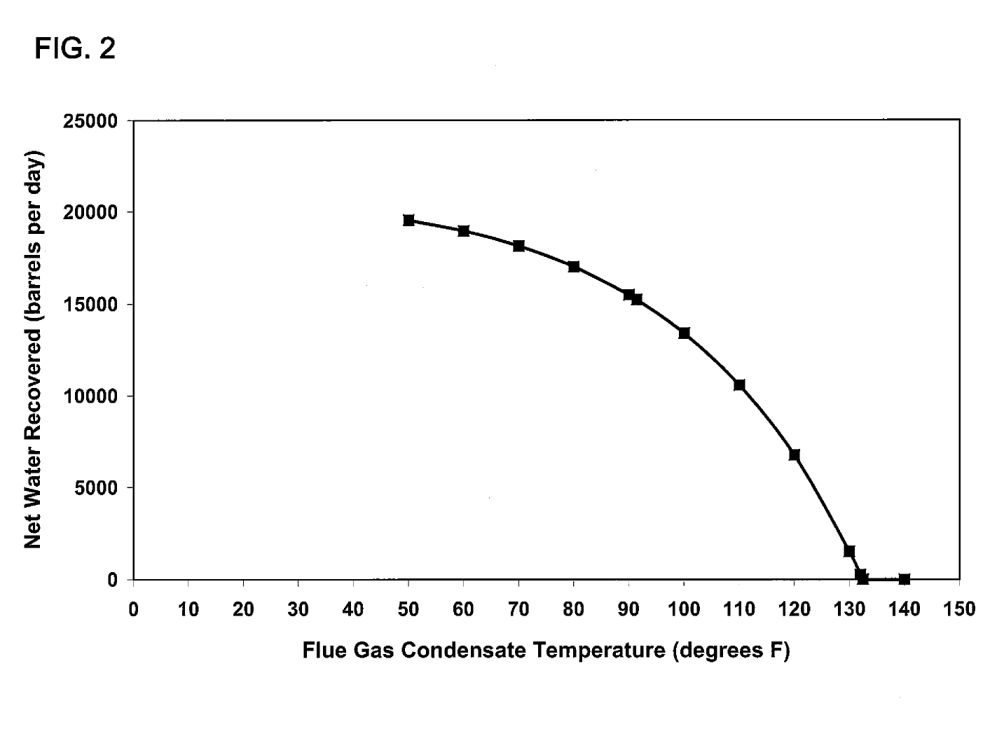

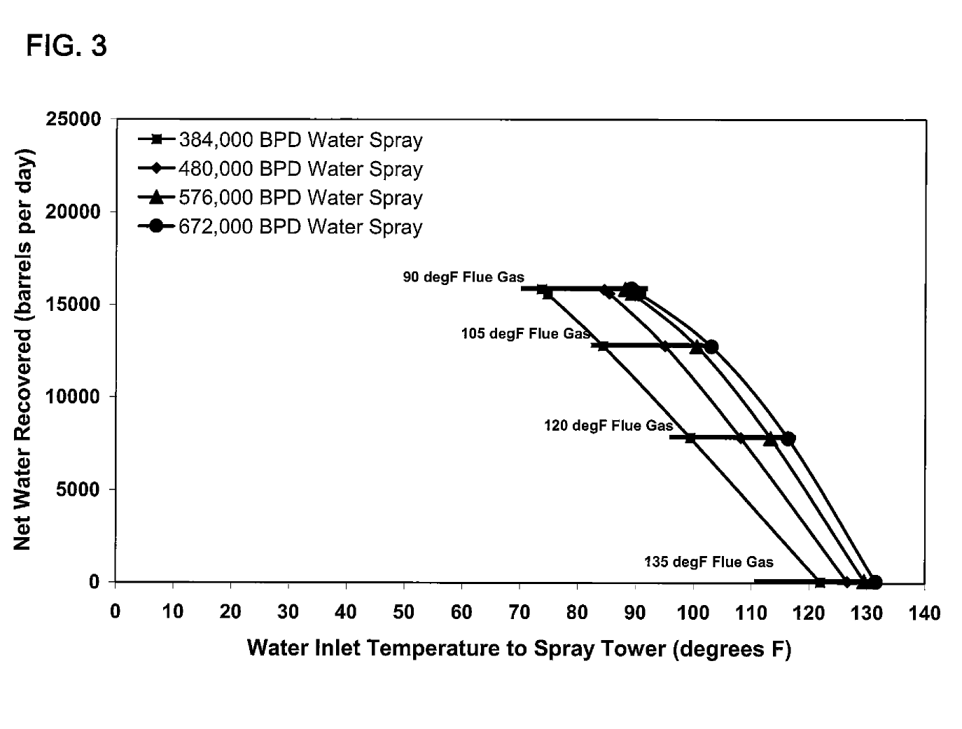

In certain embodiments, the flue gas is cooled in a water spray tower. During this step, water that is colder than the flue gas is sprayed in a spray tower and descends by gravitational force. Simultaneously, flue gas is injected below the water spray inlet and rises, creating turbulent mixing with the descending sprayed water that maximizes direct contact. Tower packing may be used to enhance the mass transfer of acid gases from the flue gas to the liquid water phase and/or enhance the heat transfer between the flue gas and the water spray. A variety of tower packing materials and configurations may be utilized, as is known by those skilled in the art. As the rising flue gas is cooled by heat transfer to the sprayed water, a portion of the water vapor carried by the flue gas condenses, mixes with the sprayed water and travels downward. Typical conditions for this direct heat exchange operation include an inlet flue gas temperature in the range of about 300 to about 400° F. from a boiler flue gas stack, and an inlet water temperature below the dew point (approximately 135° F.) of the water vapor contained within the flue gas. The temperature of the sprayed water in the water spray tower must be sufficient to cool the flue gas to a temperature that will produce the desired recovery of water from the flue gas. FIG. 2 is an example of a graph that can be used to determine this flue gas temperature. Since the circulating water is cooled in an air cooler and the efficiency of this cooling is affected by the ambient air temperature, the circulating water temperature will vary throughout the year. Hence, the amount of water condensed from the flue gas will also vary. For example, the graph of FIG. 2 (discussed in greater detail below) reveals that to produce 16,000 bpd of make-up water from the boilers of a steam-assisted production facility, the flue gas must be cooled to a spray tower exit temperature of 90° F. Meanwhile, the graph depicted in FIG. 3 (also discussed in greater detail below) shows, for example, that 16,000 bpd of make-up water can be condensed from the flue gas at a 50° F. ambient air temperature by using 480,000 bpd of total recirculating water, sprayed at a temperature of 85° F. or less. In this scenario, the water stream exiting the bottom of the spray tower will be 145° F. Thus, for this scenario, the air cooler for the recirculating water must be sufficient to cool 480,000 bpd of recirculating water from 145° F. to 85° F. using 50° F. ambient air in order to produce 16,000 bpd of make-up water. Once the equipment has been sized and the required recirculating water rate determined, then the temperatures of 1) the recirculating water, 2) the flue gas existing the spray tower, and 3) the produced make-up water can all be calculated relative to any given ambient air temperature. Certain embodiments include optimization of the equipment sizes and costs versus the desired rate of water recovery from the flue gas throughout the course of the year as the ambient temperature changes.

As the flue gas is cooled in the spray tower via direct contact with the sprayed recirculating water, acid gases present in the flue gas, such as, for example, SO₂, CO₂ and NOx, are absorbed into the recirculating water. A chemical is added to the recirculating water that can react with these absorbed acid gases to convert them to a form that prevents their release into the atmosphere, and preferably, allows them to be easily disposed of. In certain embodiments, the added chemical comprises one or more hydroxides. Examples of hydroxides that can be used include, but are not limited to: sodium hydroxide, calcium hydroxide, potassium hydroxide, ammonium hydroxide and calcium carbonate. The amount (or percentage) of acid gases removed from the flue gas correlates directly with the amount of chemical added to the recirculating water, such that it is available to react with absorbed acid gases.

The acid gas species absorbed in the water can be separated from the water to create a stream that can be further processed for sequestration or other process that prevent release of the acid gas into the atmosphere. The resulting water stream contains less impurities, and is less corrosive to the process equipment.

The mixture of commercial pipeline gas and natural gas used as fuel for the steam boiler can vary depending on how much natural gas is produced in the steam-assisted hydrocarbon production operation. Any mixture of pipeline natural gas and produced gas can be used as fuel, although it is preferable that the percentage of produced gas used in the mixture be as high as possible in order to decrease fuel costs.

In certain embodiments, the boiler flue gas has minimal sulfur content. Minimal sulfur content can be achieved by any known process known in the art. Minimal sulfur content may be achieved by chemically treating the flue gas prior to combustion. Examples of chemicals that can used to treat the flue gas to remove sulfur include, but are not limited to, chemical solvents, physical solvents and solid adsorbents. Representative examples of chemical solvents include amines such as monoethanolamine and methyldiethanolamine. Representative examples of physical solvents include methanol and dimethyl ethers of polyethylene glycol. Representative examples of solid absorbents include zinc oxide.

The practice of burning produced steam-assisted production reservoir gas is quite commonly done for economic reasons, but can introduce more sulfur contaminant into the boiler fuel, which makes the flue gas stream more acidic and corrosive due to the presence of sulfur dioxide and sulfur trioxide. The potential for corrosion of process equipment makes the condensation of water from the flue gas of boilers used in steam-assisted hydrocarbon production a unique application that is not practiced in the present art.

Another type of chemical solvent that can be utilized to remove sulfur contaminants is hydrogen peroxide. Hydrogen peroxide can be used to remove sulfur dioxide, nitrogen dioxide and other contaminants from flue gas. The use of hydrogen peroxide converts the oxide of sulfur and some of the oxide of nitrogen to more stable oxidation states. Acids formed as a result of this conversion, namely sulfuric acid (H₂SO₄) and nitric acid (HNO₃), can then be neutralized with limestone in an isolated area or enclosure away from populated areas. The following simplified chemical reactions represent the processes involved in both the creation of the contaminants and their removal through the use of hydrogen peroxide, followed by precipitation in the presence of calcium carbonate:

S+O₂ [symbol] SO₂

2N+O₂ [symbol] 2NO

H₂O₂+SO₂ [symbol] H₂SO₄

H₂O₂+2NO₂ [symbol] 2HNO₃

H₂SO₄+H₂O+CaCO₃ [symbol] CaSO₄.2H₂O+CO₂

2HNO₃+CaCO₃ [symbol] Ca(NO₃)₂+H₂O+CO₂

CO₂+H₂O [symbol] H₂CO₃ [symbol] HCO₃⁻+H⁺

HCO₃⁻+NaOH [symbol] NaCO₃+H₂O

NaCO₃+H₂CO₃ [symbol] 2HCO₃⁻+Na²⁺

It is preferable to reduce the sulfur species present in the natural gas prior to combustion of the natural gas in a steam boiler, as this reduces the levels of acidic sulfur oxides present in the flue gas, and therefore, the acidity of the water condensed from the flue gas in the spray tower. In addition to the methods described above, a method can be performed using a majority of pipeline natural gas for specific steam-assisted production boilers will also reduce the sulfur impurities and reduce the corrosivity of the recovered water. A further reduction of sulfur can be achieved by using natural gas that has not been odorized with sulfur compounds.

In certain embodiments, the combusted flue gas is partially cooled prior to entering the water spray tower by injecting a water spray directly into the flue gas to achieve a temperature that is below the condensation temperature of sulfur trioxide in flue gas (approximately 250° F.), yet remains above the dew point of water in the flue gas (approximately 135° F.) and also below the maximum working temperature limit of fiberglass reinforced plastic vessels. In these embodiments, the water spray contains at least one chemical to neutralize the pH of the combusted flue gas and prevent corrosion of the downstream equipment. Representative examples of chemicals that may be used include: sodium hydroxide, calcium hydroxide, potassium hydroxide, ammonium hydroxide.

Once the sulfur and nitrogen-based acids in the flue gas have been neutralized, the flue gas enters a water spray tower where it is further cooled to a temperature below the dew point of water within the flue gas. This allows water contained within the flue gas to condense, and allows absorption of gases such as carbon dioxide into the mixture of condensed water and sprayed water. If a hydroxide (such as one or more of those listed above) has been added to the water that is sprayed into the spray tower to cool the flue gas to a temperature below the dew point (below approximately 135° F.), carbon dioxide present in the flue gas is absorbed by the water in the spray tower and is quickly converted to carbonate and or bicarbonate ion.

Optionally, the gas used to fuel the boiler (that comprises at least one of commercial pipeline natural gas and produced gas) is treated prior to combustion to reduce sulfur content. Following combustion of the gas in the boiler, water is condensed from the resulting flue gas by introducing the flue gas into a water spray tower, where it is cooled to a temperature of about 135° F. or less by contact with a first aqueous stream that is sprayed within the tower. As a result of the cooling, at least a portion of the water vapor contained within the flue gas condenses and combines with the first aqueous stream to produce a second aqueous stream. Simultaneously, carbon dioxide present in the flu gas absorbs into both the first and second aqueous streams. A chemical is added to a first aqueous stream, preferably prior to it being sprayed in the spray tower. This chemical reacts with CO₂ absorbed into the first and second aqueous streams to produce at least one of carbonates and bicarbonates. The second water stream exiting the bottom of the spray tower is directed to a reactor where at least a portion of the carbonates and bicarbonates are removed, thereby producing a third aqueous stream.

The presence of reaction products in the water above a certain threshold concentration can precipitate and make a slurry, resulting in fouling or even plugging of the water flow inside the spray tower. In certain embodiments, these reaction products may comprise carbonate or bicarbonate. Fouling or plugging can be prevented by any of several methods, including manipulation of the pH of the spray water (via caustic addition) to control the amount of carbon dioxide absorbed (see EXAMPLES 1 and 2, below), or increasing the total volume of the first aqueous stream to dilute the concentration of the carbonate or bicarbonate ions. In certain embodiments, a physical device such as a filter may be installed inside the spray tower facilitate the removal of any precipitated material and prevent fouling in the spray tower.

Bulk removal of reaction products from the second aqueous stream downstream from the spray tower may be achieved by any conventional method known to those familiar with the art. In certain embodiments, such methods may comprise a first step for coagulation, flocculation, selective precipitation by cooling, electrostatic precipitation or mixtures thereof This first step may optionally occur within a reactor. Removal reaction products, which in certain embodiments may comprise carbonates and bicarbonates, may additionally comprise a second step for removal of the product of the first step, including separation by hydro-cyclone, incline settling, gravity settling, as well as centrifugation or filtration (including membrane filtration).

In certain other embodiments, separation of carbonate and bicarbonate ions from the second aqueous stream may be achieved by evaporating the water, thereby concentrating the carbonate and bicarbonate prior to discarding them. Such processes for evaporative water treatment are common in the art. In still other embodiments, the reactor may heat the second aqueous stream to reverse the chemical reaction and evolve CO₂ from the carbonates and bicarbonates, regenerating the original chemical added to the first aqueous stream and producing a third aqueous stream. This third aqueous stream may then be cooled by conventional heat exchange prior to sending it once again to be sprayed in the spray tower. The evolved CO₂ would be captured to prevent release into the atmosphere as a greenhouse gas that may contribute to global warming. The CO₂ could be compressed and either stored or sequestered. Sequestration may involve, for example, direct injection of the compressed CO₂ into a subterranean formation either on-site or at another location.

The second aqueous stream with carbonates and bicarbonates removed forms a third aqueous stream. Part of this third stream comprises water recovered from the flue gas that can be utilized to provide make up water (i.e., supplement the fresh water needed) for the process. Hence, a slipstream is taken off of the third aqueous stream and combined with the water stream that serves as boiler feed water. The remainder of the third aqueous stream is cooled by any conventional means of heat transfer (or exchange) to produce a first aqueous stream that is recycled to the spray tower. If the slipstream is sent directly to a boiler, preferably it is split from the third aqueous stream prior to cooling of the third aqueous stream.

Although it is possible to recover water from flue gas at temperatures ranging from 50° F. up to 135° F., for greatest efficiency (and optimal size of the spray tower and air cooler) the temperature of the cooled flue gas exiting the spray tower is preferably between about 80° F. to about 100° F. In certain embodiments, the temperature of the flue gas is about 90° F. In certain embodiments, more than 25% of the water required for the steam-assisted production process is obtained from water recovered from boiler flue gas. In certain other embodiments, more than 50% of the water required for the steam-assisted production process is obtained from water recovered from boiler flue gas.

In certain embodiments, an absorber bed is utilized in the spray tower to improve the contacting efficiency for acid gas removal. For economic reasons, it may be optimal to design the packing to cause minimal pressure drop in the system so that the flue gas can be moved through the spray tower by increasing the size of the boiler combustion air blower instead of installing an additional air blower or induced draft fan to move the flue gas. Different types of absorber bed packing formats that can be used include: random packing with plastic such as polypropylene or metal such as stainless steel or structured packing made of metal such as stainless steel. One of the determining factors when choosing an appropriate absorber bed material is its ability to provide effective contacting of the flue gas and the water spray components while also being corrosion resistant to these process fluids.

The above-mentioned absorber bed may optionally be built directly into the boiler flue gas stack, which eliminates the need for additional piping or ducting that would increase the pressure drop in the system. If the absorber bed is located directly inside the flue gas stack, a collector plate is placed underneath the bottom of the bed to allow the gas to pass upward through ‘chimneys’ in the plate while at the same time collecting the falling water onto the plate's top surface so it could be removed from the system. Such designs are known by those having skill in the art.

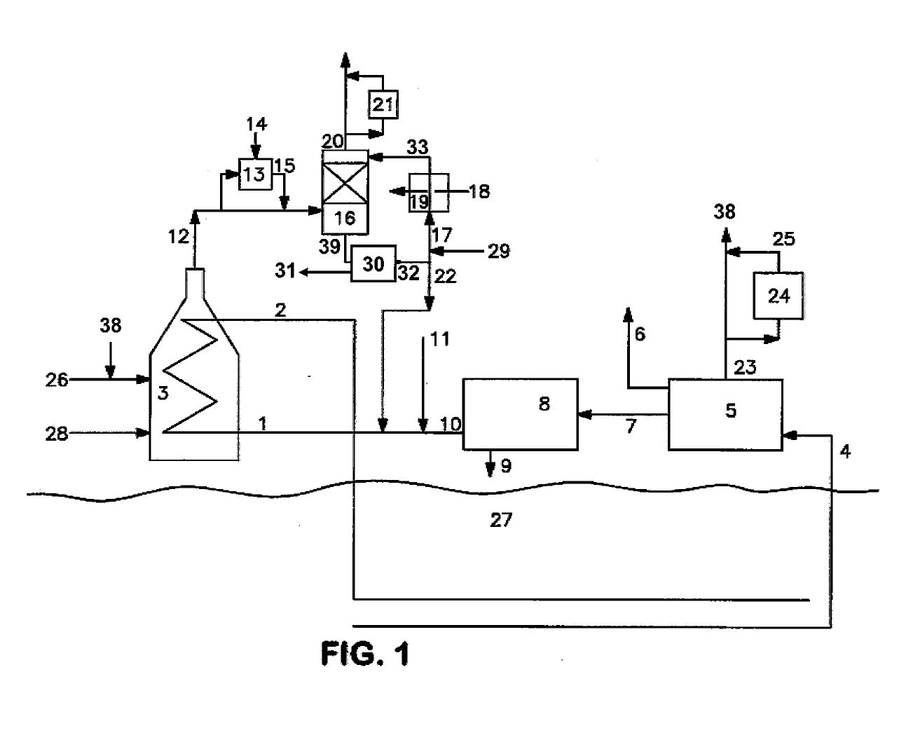

FIG. 1 depicts a flow diagram representing an embodiment of the present invention for producing make-up water and removing acid gases from the flue gas of a steam-assisted production facility. A water stream 1 is converted to steam 2 in a steam boiler system 3 that burns commercial pipeline natural gas, 26, and/or produced gas, 38, with air 28. The produced gas 38 (detailed further below) can comprise cleaned produced gas 25, standard produced gas 23, or combinations thereof. The steam 2 is injected underground into a bitumen reservoir 27 and a product mixture 4 of bitumen, water and gas is produced to the surface. This product mixture 4 is sent to a separation facility 5 that separates the product mixture 4 into bitumen 6, produced water 7, and standard produced gas 23. The bitumen 6 may have diluent added to it in the separation facility 5 to assist in the separation. The produced water 7 is sent to a water treatment facility 8 to clean the water and make it suitable for return to the boiler. Any known conventional process can be used for this water treatment. Typically, the water treatment facility 8 produces a cleaned produced water stream 10 as well as separating and removing a purge stream 9 that is high in contaminants. The water stream returned to the boiler 1 comprises a mixture of the cleaned produced water stream 10 with a make-up water stream 22 that comprises water recovered from boiler flue gas (as detailed below) and if needed, a supplemental external water supply 11 that may be, for example, fresh water from an underground well, desalinated water, or water from a municipal water supply.

In certain embodiments, the flue gas 12 exits the boiler system at approximately 300-400° F. and is vented to the atmosphere. In the embodiment depicted in FIG. 1, the flue gas 12 is pre-cooled by injecting a water stream 14 into the flue gas 12 via an injection device 13. This water stream may contain chemical capable of increasing the pH and facilitating the removal of acidic sulfur species. The resultant stream 15 has a temperature below the condensation point of sulfur trioxide in the flue gas and below the maximum working temperature of fiberglass reinforced plastic vessels, but above about 135° F., which is the dew point of the flue gas.

The flue gas 12 is sent to a spray tower 16, where it is cooled by a first aqueous stream sprayed at the top of the tower and allowed to flow downward. The sprayed first aqueous stream combines with water vapor condensed from flue gas and any acidic gas species absorbed by the resultant aqueous mixture to produce a second aqueous stream that exits the bottom of the spray tower 39. In certain embodiments, the acidic gas species absorbed into the second aqueous stream may be CO₂, which upon being absorbed, is quickly converted into bicarbonates and/or carbonates by reacting with a chemical added to the water stream. These embodiments would involve removal of these carbonates and/or bicarbonates from the second aqueous stream in reactor 30. The reactor 30 produces a waste stream 31 that is rich in bicarbonates, carbonates, and/or CO₂ and can be further processed for possible CO₂ sequestration or other conventional processes to prevent the CO₂ from being released as a greenhouse gas into the atmosphere. The separator device also produces a third aqueous stream 32 that is largely free of carbonates and bicarbonates, as well as absorbed CO₂. A portion of the third aqueous stream is diverted to produce make-up water stream 22, which represents water recovered from the flue gas and returned to the process. Make-up water stream 22 is combined with the cleaned produced water stream 10 and optionally, an external water supply 11, to serve as feed water for boiler 3. The make-up water stream 22 can reduce (or in some instances, eliminate) the quantity of external water supply 11 needed by the process. In geographic areas where water supply is limited or government regulations restrict water use, make-up water stream 22 not only makes the process more efficient, but may enable the process to be performed in areas where lack of available water would otherwise prevent it. The remainder of the third aqueous stream 17 is cooled in air cooler 19 using ambient air stream 18, to produce the first aqueous stream 33, which is then sent back to the spray tower 16.

Again referring to FIG. 1, a chemical 29 is added to increase the pH of the third aqueous stream 17 to reduce the corrosion in the air cooler 19, the spray tower 16, and associated equipment and piping. This chemical 29 is preferably added to the recirculating aqueous stream in quantities that also facilitate the conversion of acid gases absorbed by the aqueous streams to carbonates, bicarbonates, and mixtures thereof. In certain alternative embodiments (not depicted), chemical 29 may be added to the make-up water stream 22 so as to increase the pH of the make-up water slipstream, thereby preventing corrosion of the steam boiler. A treated flue gas 20 exits the top of the spray tower. If there is significant pressure drop within the system, an induced draft fan 21 may be optionally be used to pull the treated flue gas 20 through the duct and/or a blower may be used on the flue gas stream before it reaches the spray tower. A make-up water stream 22 is taken from the water exiting the bottom of the spray tower and represents the additional make-up water that is added to the cleaned produced water stream 10.

The standard produced gas 23 from the separation facility can be combusted in the boiler 3. This produced gas stream can be used to reduce the amount of commercial pipeline natural gas, 26, used in the boiler. Because the standard produced gas 23 contains sulfur and other impurities, the standard produced gas 23 may be sent to a gas treatment facility 24 to remove sulfur and other impurities resulting in cleaned produced gas 25 which can be sent to the boiler instead of, or combined with 38, the standard produced gas 23. In certain embodiments, the gas treatment facility 24 is capable of lowering emissions from the boiler system 3 and reducing the corrosiveness of the flue gas 12, the make-up water stream 22, and extend the lifespan of the process equipment and associated piping.

FIG. 2 depicts a graph describing the amount of water that can be recovered from a 90,000 bpd steam-assisted production facility operating at a 2.5:1 steam:oil ratio. It can be shown from this table that there is a correlation between the amount of water recovered and the temperature of the flue gas.

Using the example from FIG. 2, a SAGD production facility that recovers approximately 90,000 bpd requires 225,000 bpd of water to operate (90,000 bpd oil×2.5 steam/oil ratio=225,000 bpd water). Assuming a 93% recovery of the steam-assisted production water injected downhole means that approximately 15,750 bpd of make-up water is needed to assure constant operation (225,000 bpd water needed×(1−0.93)=15,750 bpd of make-up water). In FIG. 2, the ambient air temperature is 50° F. and results in 90° F. flue gas, which in turn, provides 16,000 bpd of make-up water. Thus, it is hypothetically possible that all of the make-up water needed in a steam-assisted production facility can be supplied by the present method. At ambient air temperatures lower than 50° F., a slight excess of make-up water may be recovered from the flue gas, while at temperatures above 50° F. a significant portion of the make-up water needed can be recovered from the flue gas.

FIG. 3 depicts a graph showing the effects of higher water recirculation flow. Higher recirculation rates allow for a higher recirculating water temperature and less spray tower packing to achieve the same flue gas temperature and hence the same produced make-up water rate as per FIG. 2, but increases the size of the recirculation equipment. For the case of 90° F. flue gas where the produced make-up water balances the needs of the steam-assisted production facility at 93% recovery, FIG. 3 shows that increasing the water circulation rate from 384,000 bpd to 480,000 bpd allows the temperature of the sprayed water stream that cools the flue gas to increase by 10° F.; this substantially reduces the size of the heat exchange equipment required to cool the circulating water. Higher circulation rates above 480,000 bpd produced much smaller gains in the sprayed water temperature required to cool the flu gas and hence 480,000 bpd recirculation rate is considered the minimum. This makes the optimal ratio of water circulation to condensed make-up water 480,000:16,000, or 30:1 for this example, where the temperature of the flue gas is reduced to 90° F.

### EXAMPLE 1

The presence of carbonate or bicarbonate above a certain threshold concentration in the first aqueous stream can precipitate, potentially fouling (or even plugging) the water flow inside the spray tower. This fouling or plugging can be controlled by any of several methods, including regulating the pH of the spray water (via caustic addition) to control the amount of carbon dioxide absorbed

It is possible to control the amount of carbon dioxide absorbed into the water spray by regulating the pH. The results of two experiments conducted in our laboratory demonstrate this. In the first experiment, methane gas containing 100 ppm H₂S was combusted and passed through a glass column with glass bead packing and water was introduced to cool the flue gas. The water stream from the column (containing the water spray plus the water condensed from the flue gas) was collected in a vessel where it was neutralized with a caustic solution made by adding 1 gram of a 20% (by wt.) NaOH solution to 100 grams of water). The amount of NaOH added was regulated to maintain a specified pH as the water absorbed acid gas from the column. The vessel had an overflow line to maintain a constant liquid level, while the excess water was taken off as product water and the quantity measured.

Without neutralization by NaOH addition, the measured pH of the water was 2.7. When NaOH was added to maintain the pH of the spray water at 5.5, addition of nearly 10 ml of 0.2% (by wt.) NaOH solution was required for every 100 ml of product water. This amount is above that required to neutralize the sulfur species present in the flue gas and some of the carbon dioxide from the flue gas was also absorbed, although not all. When the NaOH was added to maintain the spray water at a pH of 8, the amount of 0.2% (by wt.) NaOH solution required to maintain pH increased to over 60 ml for every 100 ml of product water. In this experiment, nearly all of the carbon dioxide was absorbed into the spray water.

### EXAMPLE 2

An additional experiment was conducted to further optimize the pH range at which carbon dioxide absorption is maximized. For this experiment, 10 ppm of ethyl mercaptan was added to a methane fuel, and the mixture combusted to make a flue gas. To maintain the spray water at a pH of 6 required the addition of 400% more caustic than was required to maintain a pH of 5. Thus, it was concluded that a pH of around 6 was the threshold for significant absorption of carbon dioxide from flue gas into the spray water.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents. Each and every claim below is hereby incorporated into this detailed description or specification as an additional embodiment of the present invention.

We claim:

1. A process for removing acid gases and recovering water from a flue gas, comprising:
a) providing a flue gas comprising combustion products of a fuel gas, and introducing the flue gas into a water spray tower;
b) adding a chemical to a first aqueous stream, and introducing the first aqueous stream into a water spray tower;
c) cooling the flue gas by direct contact with the first aqueous stream in the water spray tower and condensing at least a portion of the water vapor present in the flue gas, wherein the condensed water vapor combines with the first aqueous stream to produce a second aqueous stream;
d) reacting the chemical with acid gases absorbed into at least one of the first aqueous stream and second aqueous stream, thereby forming reaction products;
e) removing a majority of the reaction products from the second aqueous stream, thereby producing a third aqueous stream and a waste stream;
f) diverting a portion of the third aqueous stream as a make-up water stream and routing the make-up water stream to the boiler of step (a), thereby minimizing the quantity of external water supply needed for the process;
g) cooling the remainder of the third aqueous stream to produce the first aqueous stream of step b).

2. The method of claim 1, wherein the chemical is selected from the group consisting of alkaline earth hydroxides, sodium hydroxide, potassium hydroxide, ammonia and ammonium hydroxide.

3. The method of claim 1, wherein after the second aqueous stream leaves the water spray tower the reaction products are removed from the second aqueous stream by precipitation, followed by a member of the group comprising filtration and gravity settling.

4. The method of claim 1, wherein the reaction products are removed from the second aqueous stream by a method comprising:
a first step for comprising coagulation, flocculation, selective precipitation by cooling, electrostatic precipitation or mixtures thereof, thereby creating a solid product;
a second step for separating the solid product of the first step from the second aqueous stream, wherein the second step comprises separation by hydro-cyclone, incline settling, gravity settling, centrifugation, filtration or mixtures thereof.

5. The method of claim 1, wherein the flue gas is produced by the combustion of a fuel gas comprising produced gas, pipeline gas or mixtures thereof.

6. The method of claim 1, wherein the flue gas is produced by a furnace associated with the refining of liquid hydrocarbons.

7. The method of claim 1, wherein the flue gas is produced by a boiler that generates steam for a steam-assisted hydrocarbon production process.

8. The method of claim 1, wherein the flue gas passes through a flue stack that also serves as the water spray tower.

9. The method of claim 1, wherein water recovered from the flue gas comprises more than 25% of the water used in the process.

10. The method of claim 1, wherein the chemical added to the first aqueous stream increases the pH of the first aqueous stream and maintains the pH at a predetermined pH value to regulate the amount of acid gases absorbed by first aqueous stream.

11. The method of claim 10, wherein the predetermined pH value utilized is greater than or equal to the pH required to facilitate the absorption of a significant percentage of the acid gases present in the flue gas into the first aqueous stream, wherein the predetermined pH value utilized is less than or equal to the pH required to prevent precipitation of solids from the second aqueous stream.

12. The method of claim 1, wherein sulfur compounds are removed from the flue gas by chemically-treating the fuel gas prior to combustion in the boiler, wherein the treatment comprises contact with at least one chemical selected from the group comprising: chemical solvents, physical solvents and solid adsorbents.

13. The method of claim 1, wherein prior to entering the water spray tower, the flue gas is partly-cooled by direct contact with a water spray to a temperature that is above the dew point of water vapor in the flue gas, but below the condensation temperature of sulfur trioxide in flue gas and below the working temperature limit of fiberglass reinforced plastic vessels, wherein said water spray contains at least one chemical to react with and neutralize any SO₃, NOx, or mixtures thereof present in the flue gas.

14. A process for removing acid gases and recovering water from a flue gas, comprising:
a) providing a flue gas produced from a boiler associated with a steam-assisted hydrocarbon production facility, wherein said flue gas comprises combustion products of commercial pipeline gas, produced gas or mixtures thereof;
b) adding a chemical to a first aqueous stream, and introducing the first aqueous stream into a water spray tower, wherein the chemical is selected from the group consisting of alkaline earth hydroxides, sodium hydroxide, potassium hydroxide, ammonia and ammonium hydroxide;
c) cooling the flue gas by direct contact with the first aqueous stream in the water spray tower and condensing at least a portion of the water vapor present in the flue gas, wherein the condensed water vapor combines with the first aqueous stream to produce a second aqueous stream;
d) reacting the chemical with acid gases absorbed into at least one of the first aqueous stream and second aqueous stream to form reaction products comprising carbonates, bicarbonates, and any mixtures thereof;
e) routing the second aqueous stream away from the water spray tower and removing a majority of the reaction products from the second aqueous stream, thereby producing a third aqueous stream and a waste stream;
f) diverting a portion of the third aqueous stream as a make-up water stream and routing the make-up water stream to the boiler of step (a), thereby minimizing the quantity of external water supply needed for the process;
g) cooling the remainder of the third aqueous stream to produce the first aqueous stream of step b).

15. The method of claim 14, wherein the chemical added to the first aqueous stream increases the pH of the first aqueous stream and maintains the pH at a predetermined pH value to regulate the amount of acid gases absorbed by first aqueous stream.

16. The method of claim 15, wherein the predetermined pH value utilized is greater than or equal to the pH required to facilitate the absorption of a majority of the acid gases present in the flue gas into the first aqueous stream, wherein the predetermined pH value utilized is less than or equal to the pH required to prevent precipitation of solids from the second aqueous stream.

17. The method of claim 15, wherein the predetermined pH value is a pH in the range of about pH 5.5 to about pH 8.

18. The method of claim 14, wherein the flue gas passes through a flue stack that also serves as the water spray tower.

19. The method of claim 14, wherein water condensed from the flue gas comprises greater than 50% of the water used in the process.

20. The method of claim 14, wherein sulfur compounds are removed from the flue gas by chemically-treating the fuel gas prior to combustion in the boiler, wherein the treatment comprises contact with at least one chemical selected from the group comprising: chemical solvents, physical solvents and solid adsorbents.

21. The method of claim 14, wherein prior to entering the water spray tower, the flue gas is partly-cooled by direct contact with a water spray to a temperature that is above the dew point of water vapor in the flue gas, but below the condensation temperature of sulfur trioxide in flue gas and below the working temperature limit of fiberglass reinforced plastic vessels, wherein said water spray contains at least one chemical to react with and neutralize any SO₃, NOx, or mixtures thereof present in the flue gas.
